(19) United States
(12) Patent Application Publication
(10) Pub. No.: US 2014/0166739 A1
(43) Pub. Date: Jun. 19, 2014

(54) PROCESS AND APPARATUS UTILIZING QR CODES WITH EXERCISE MATS

(71) Applicant: Michael F. Savage, Santa Monica, CA (US)

(72) Inventor: Michael F. Savage, Santa Monica, CA (US)

(21) Appl. No.: 14/105,911

(22) Filed: Dec. 13, 2013

Related U.S. Application Data
(60) Provisional application No. 61/737,359, filed on Dec. 14, 2012.

(51) Int. Cl. G06F 17/30; G06K 19/06

(52) U.S. Cl. CPC G06F 17/30879; G06K 19/06037
USPC 235/375; 235/494

(57) ABSTRACT

A process and apparatus utilizing QR codes with exercise mats includes scanning QR codes printed on an exercise mat with a tablet computer or hand-held mobile device. Once decoded, the QR code directs an on-board web browser on the tablet computer or hand-held mobile device to a website where exercises are described and demonstrated. The exercises are performed on the flexible mat.

### FIELD OF THE INVENTION

The present invention generally relates to QR codes applied to products. More particularly, the present invention relates to a process and apparatus utilizing QR codes with exercise mats.

### BACKGROUND OF THE INVENTION

In today's modern world, a sedentary lifestyle is extremely common. Desk jobs, long commutes and excessive television watching mean that an average adult spends most of his or her day sitting down. The resulting lack of exercise leads to multiple health issues. These health issues include but are not limited to obesity, joint and back pain, high blood pressure, hypertension, migraines and fatigue. Many people attempt to combat the effects of their sedentary lifestyle by increasing their level of exercise. Typically, a person will hire a personal trainer, join a gym or purchase in-home exercising equipment. Each of these options present a different set of problems.

Personal trainers offer one-on-one guidance but are usually very expensive. Personal training appointments can also be very time consuming. A gym membership is typically expensive as well and many find it inconvenient to drive to a separate location, change clothes, and wait for equipment to be open only to exercise in front of a room of strangers. In-home exercise equipment can also be very expensive. Treadmills, elliptical machines, and weightlifting equipment are heavy and take up a lot of space. A user may purchase exercise books or videos but these are problematic as well. When reading about exercises in a book, it is hard to know if the exercises are being correctly performed. Likewise, a video may show a user the correct form for an exercise but the order of exercises performed from a video cannot be customized to the user's individual preferences.

Current advances in technology provide options for improving the in-home exercise experience. One such technological advance is the quick response or QR code. The QR code is a two-dimensional code, also called a matrix barcode. A QR code consists of square dots arranged in a square pattern on a white background. Much like a traditional barcode, a QR code can be printed on a wide range of packages and products. The QR code differs from the traditional barcode in that rather than being mechanically scanned by a narrow beam of light as with a traditional barcode, the QR code is detected as a two-dimensional digital image by a semiconductor image sensor and is then digitally analyzed by a program processor. Depending on the size and complexity of the QR code, eighteen hundred to seven thousand characters can be encoded in a single QR code. Micro QR codes can be used to encode fewer than thirty-five characters.

codes have become very common in consumer advertising and packages but recently QR codes are pervasively used in connection with mobile hand-held devices. These devices include but are not limited to Google®'s Android® SmartPhone and Apple's iOS devices (the iPhone®, the iPod®, the iPad®). Using this type of hand-held device, a user can utilize the onboard camera to scan a QR code. Once the QR code is decoded, the device's web browser is automatically directed to a web page. This process has been termed “hardlinking” or “object hyperlinking”.

Accordingly, there is a need for a process and apparatus utilizing QR codes in relation to in-home exercising. The present invention fulfills these needs and provides other related advantages.

### SUMMARY OF THE INVENTION

An exercise apparatus in accordance with the present invention comprises a rollable, flexible exercise mat, and a plurality of quick response (QR) codes visible on a surface of the exercise mat, wherein the QR codes, when scanned by a QR code reader, open one or more websites to illustrate an exercise to be performed utilizing the exercise mat. In a preferred embodiment, the exercise mat comprises a yoga mat, and the QR codes open one or more websites directed to yoga, pilates, stretch and/or cardio exercises. A visual illustration may be associated with one or more of the QR codes, illustrating the exercise to be performed utilizing the exercise mat.

As illustrated, the QR codes associated with a similar type of exercise are grouped together. The exercise mat may include a non-skid or quick-drying surface. Moreover, the exercise mat may comprise an antibacterial or antimicrobial material.

The exercise apparatus of the present invention further includes including a tablet computer or a hand-held mobile device comprising an integrated camera, software for decoding QR codes, an on-board web browser, and means for connecting to the Internet.

A process for utilizing the exercise apparatus of the present invention includes the steps of providing a tablet computer or a hand-held mobile device comprising an integrated camera, software for decoding QR codes, an on-board web browser, and means for connecting to the Internet, utilizing the integrated camera to scan a selected QR code on the flexible exercise mat, decrypting the information provided by the QR code by means of the software provided within the tablet computer or the hand-held mobile device, and displaying content from a website on the Internet and accessed through the web browser relating to the scanned QR code.

The website may comprise text, pictures and/or embedded videos describing or demonstrating the exercise associated with the QR code. Further, the website may describe or demonstrate a single exercise or a progression through a series of exercises.

### BRIEF DESCRIPTION OF THE DRAWINGS

The accompanying drawings illustrate the invention. In such drawings:

FIG. 1 is a perspective view of the apparatus of the present invention illustrating a flexible mat rolled up;

FIG. 2a is a front view of a tablet computer;

FIG. 2 is a front view of a hand-held mobile computing device;

FIG. 3 is a front view of the flexible mat of the present invention, illustrating a series of QR codes and corresponding exercise illustrations printed onto the flexible mat;

FIG. 4 is an enlarged view of a quick response code taken from circle 4 of FIG. 5;

FIG. 5 is a perspective view of the apparatus of the present invention illustrating QR codes printed on the flexible mat and a person performing an exercise on the flexible mat;

FIG. 6 is a front view of a hand-held mobile computing device displaying an exercise video after reading a QR code from the flexible mat of FIG. 5;

FIG. 6a is a front view of a tablet computer displaying an exercise video after reading a QR code from the flexible mat of FIG. 5;

FIG. 7 is an enlarged view of another QR code taken from circle 7 of FIG. 8;

FIG. 8 is a perspective view of the apparatus of FIG. 5;

FIG. 9 is a front view of a hand-held mobile computing device displaying another exercise video after reading the QR code of FIG. 7 from the flexible mat of FIG. 8;

FIG. 9a is a front view of a tablet computer displaying the same video of FIG. 9 after reading the QR code of FIG. 7 from the flexible mat of FIG. 8;

FIG. 10 is an enlarged view of another QR code taken from circle 10 of FIG. 11;

FIG. 11 is a perspective view of the apparatus of FIG. 5;

FIG. 12 is a front view of a hand-held mobile computing device displaying another exercise video after reading the QR code of FIG. 10 from the flexible mat of FIG. 11;

FIG. 12a is a front view of a tablet computer displaying the same video of FIG. 12 after reading the QR code of FIG. 10 from the flexible mat of FIG. 11;

FIG. 13 is an enlarged view of another QR code taken from circle 13 of FIG. 14;

FIG. 14 is a perspective view of the apparatus of FIG. 5;

FIG. 15 is a front view of a hand-held mobile computing device displaying another exercise video after reading the QR code of FIG. 13 from the flexible mat of FIG. 14; and

FIG. 15a is a front view of a tablet computer displaying the same video of FIG. 15 after reading the QR code of FIG. 13 from the flexible mat of FIG. 14.

### DETAILED DESCRIPTION OF THE PREFERRED EMBODIMENTS

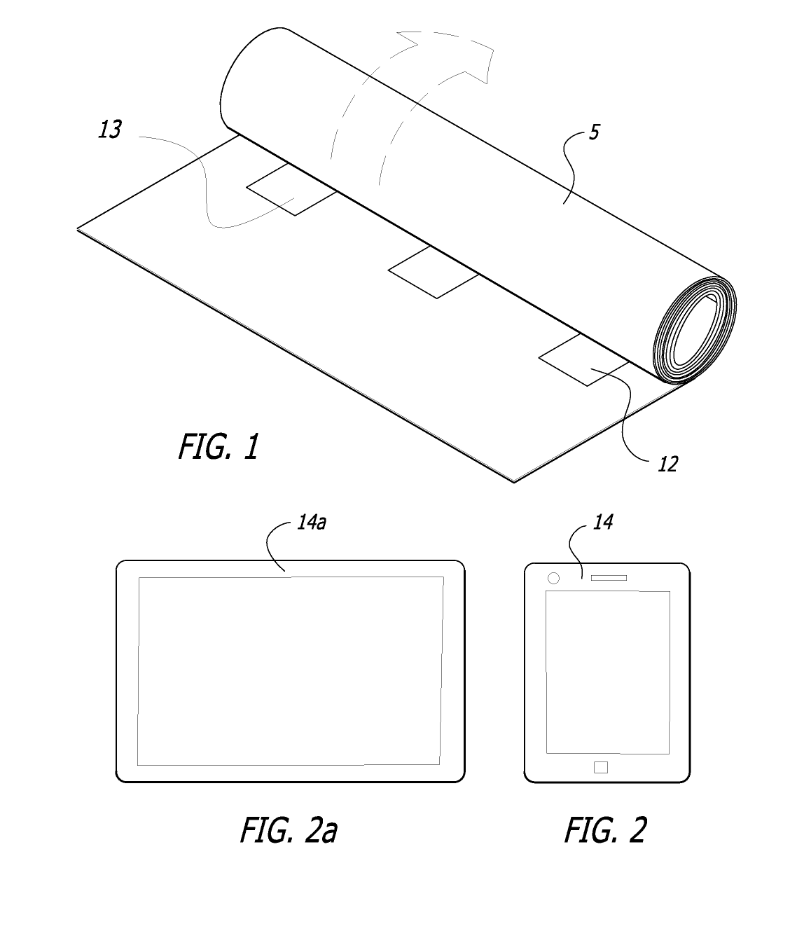

The apparatus of the present invention is generally referred to by the reference number 5. The preferred embodiment of this apparatus is a flexible mat 5 as shown in FIGS. 1 and 2. The flexible mat 5 is commonly referred to as a yoga mat. This flexible mat 5 is generally manufactured from plastic or rubber and is cushioned so as to be comfortable when used in combination with various exercises. The flexible mat 5 is rollable as shown in FIG. 1 and can also be non-skid or quick-drying. The flexible mat 5 can also be manufactured from materials that tend to be antibacterial/antimicrobial to ensure that the exercise surface is safe to use over long periods of time. As shown in the preferred embodiment, the flexible mat 5 can be generally rectangular but in other embodiments, the flexible mat 5 can be any shape that is conducive for exercising. In FIG. 1, the flexible mat 5 is shown mostly rolled up. When rolled up, the flexible mat 5 is easily transported and stored. Due to the material the flexible mat 5 is made of, the flexible mat 5 can be rolled up and stored for long periods of time without effecting the cushioned nature of the flexible mat 5.

A tablet computer 14a is illustrated FIG. 2a. Tablet computers are self-contained and much smaller than a typical laptop computer. Apple's iPad® is currently the most popular type of tablet computer, but there are several other types of tablet computers available from companies like Microsoft®, Motorola®, Samsung®, Acer®, and Amazon®. In order to be used in the present process, the tablet computer 14a must have an integrated camera (not shown), appropriate software for decoding QR codes, an on-board web browser, and means for connecting to the Internet. The means for connecting to the Internet may include a connection to a cell phone carrier's data network, a Wi-Fi signal, or a connection to another computing device.

A hand-held mobile device 14 is illustrated in FIG. 2. Apple®'s iPhone® and iPod® are currently the most popular types of hand-held mobile devices. Other companies such as Google® and Samsung® make cellphones that are capable of being used in the present process. Much like the tablet computer 14a, the hand-held mobile device 14 must have an integrated camera (not shown), appropriate software for decoding QR codes, an on-board web browser, and means for connecting to the Internet. The means for connecting to the Internet may include a connection to a cell phone carrier's data network, a Wi-Fi signal, or a connection to another computing device.

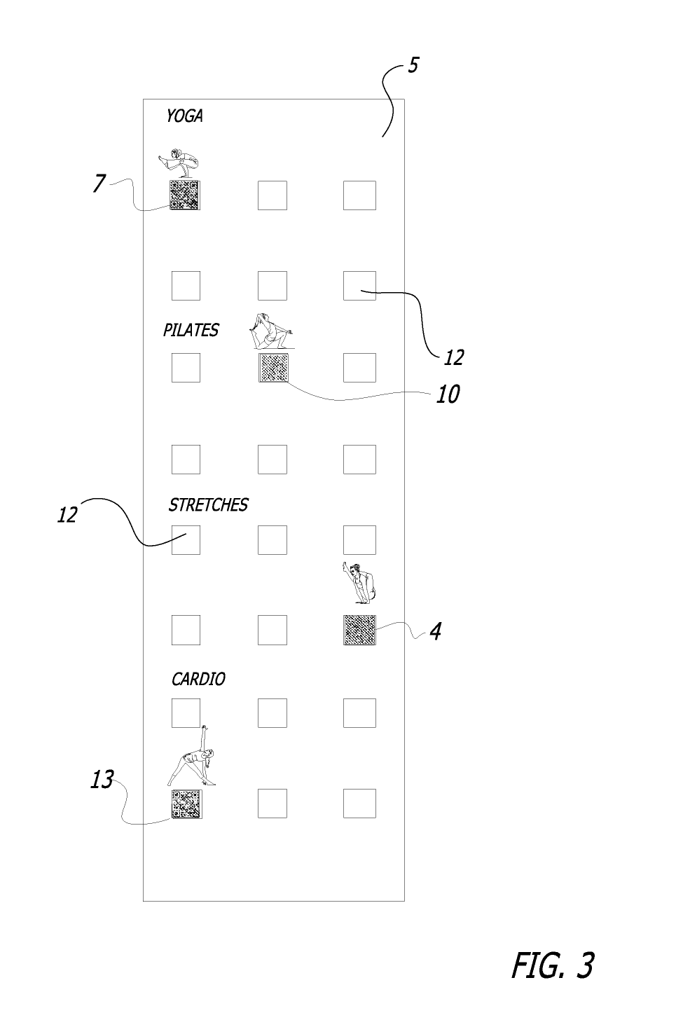

FIG. 3 shows the flexible mat 5 unrolled. The flexible mat 5 is printed with a series of QR codes 12. The QR codes 12 may be divided according to the type of exercise that corresponds to each QR code 12. For example, in FIG. 3, the QR codes 12 are grouped according to “Yoga”, “Pilates”, “Stretches”, and “Cardio”. Also, an illustration of the corresponding exercise may be printed onto the flexible mat 5 next to the QR code 12. In FIG. 3, a yoga pose is printed on the flexible mat 5 above QR code 7, a pilates pose is printed above QR code 10, a stretch is printed above QR code 4, and a cardio exercise is printed above QR code 13.

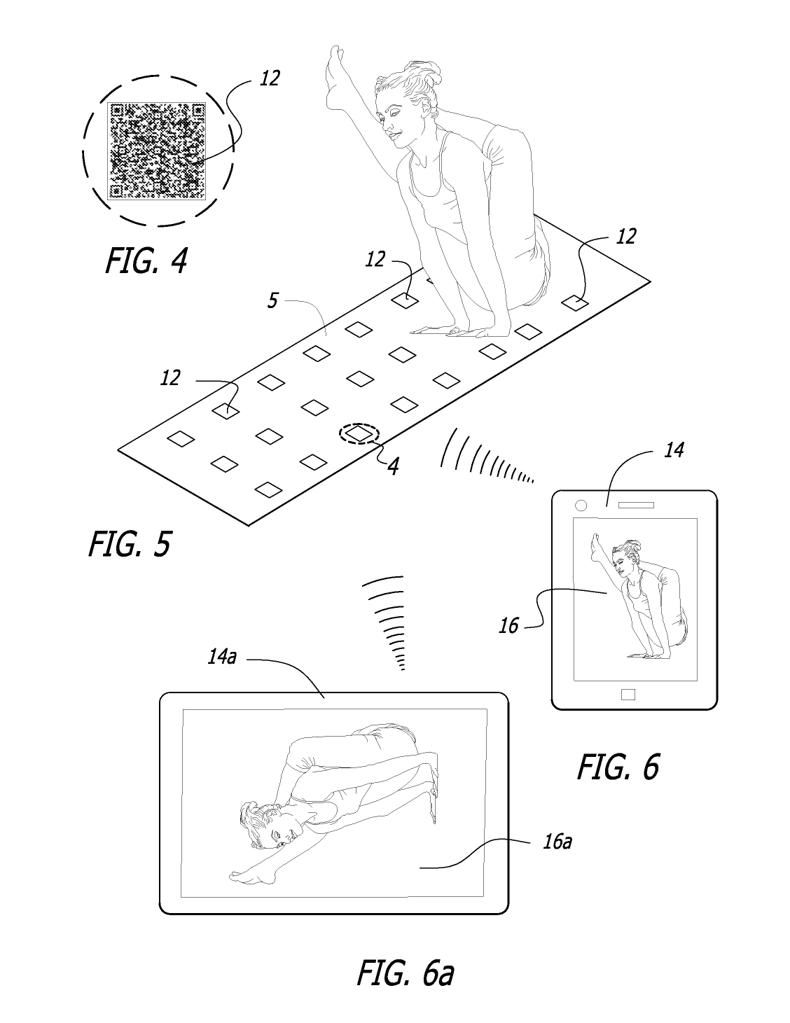

FIG. 4 illustrates an enlarged view of a quick response, or QR code 12, taken from circle 4 of FIG. 5. The QR code 12 consists of a series of square dots of varying sizes arranged in a pattern. The QR code 12 is detected as a two-dimensional digital image by a semiconductor image sensor and is then digitally analyzed by a program processor. In the present process, the semiconductor image sensor that reads the QR code 12 is the integrated camera of a tablet computer, as in FIG. 2a, or a hand-held mobile device, as in FIG. 2.

In FIG. 5, the flexible mat 5 is shown unrolled and in use. Here, the flexible mat 5 is printed with a series of QR codes 12. In the preferred embodiment, the QR codes 12 are grouped according to associated exercises. However, in other embodiments, the QR codes 12 can be incorporated into artistic designs, border patterns or other groupings. The QR codes 12 can be printed on one or both sides of the flexible mat 5. The QR codes 12 are also scalable—meaning they can be printed as large or small as needed as long the resulting QR code 12 image is still readable by the mobile device 14. As such, the flexible mat 5 can be printed with very large numbers of QR codes 12 and still be readable by the hand held mobile device 14, or tablet computer 14a. The flexible mat 5 may be used to perform the illustrated exercises on because it is made from a soft, cushioned material. As shown, even strenuous exercises can be performed on the flexible mat 5 without fear of injury or slipping.

In use, the process for utilizing QR codes 12 in association with a flexible mat 5 for the purpose of exercising begins when the flexible mat 5 is unrolled. At that point, the user can decide what exercise or exercises he would like to perform. Next, the user activates his tablet computer 14a or hand-held mobile device 14 and begins the QR code reader which has been programmed into either device. The user scans one or more QR codes 12 from the flexible mat 5 with the onboard camera of the tablet computer 14a or hand-held mobile device 14 (as shown in FIGS. 6a and 6 respectively). The QR code decrypting software on the tablet computer 14a or hand-held mobile device 14 then decrypts the information contained within the QR codes 12 and the integrated web browser on the device is automatically directed to a website or websites associated with the QR codes 12 that have been scanned. The user then proceeds to perform the exercises as demonstrated on the website or websites now displayed on the tablet computer 14a or hand-held mobile device 14. It is particularly desirable to perform the directed exercises on the flexible mat 5, as it provides a padded and non-skid surface appropriate for exercising.

As stated above, in order to be successfully utilized in conjunction with the described apparatus, the tablet computer 14a or hand-held mobile device 14 must meet certain requirements. Specifically, the tablet computer 14a or hand-held mobile device 14 must include an integrated onboard camera, a fully functional web browser and also must have sufficient processing power in order to decrypt the QR codes 12. For this purpose it is preferred that the present apparatus is used in conjunction with a smart phone such as Google®'s Android® SmartPhone or Apple's iPhone® smart phone. Other devices that meet the required qualifications include Apple's iPod® or iPad®. These devices as well as any other similarly situated device can have QR code decryption software installed on them.

When a QR code 12 is scanned with the camera of the tablet computer 14a or hand-held mobile device 14, the QR code decryption software automatically causes the mobile device 14 web browser to be directed to the appropriate website. The appropriate website may be designed with text, pictures and embedded videos describing and demonstrating the exercise associated with the QR code 12 printed on the flexible mat 5. The text, pictures and video may demonstrate and describe a single exercise or may progress through a series of exercises. Additionally, the web page and embedded videos may include audio files with music or verbal descriptions describing the exercises shown.

Once the user has successfully scanned the QR codes 12, as desired from the flexible mat 5, the user may then perform those exercises in comfort on the flexible mat 5 while watching the exercises demonstrated on the tablet computer screen 16a or the hand held mobile device screen 16 (as shown in FIGS. 5a and 5). As such, the user reduces his risk of accident or injury from incorrectly performing the desired exercises because the user is performing the exercises as they are demonstrated right in front of him. Once the user is finished exercising, the flexible mat 5 is easily cleaned and rolled up for storage.

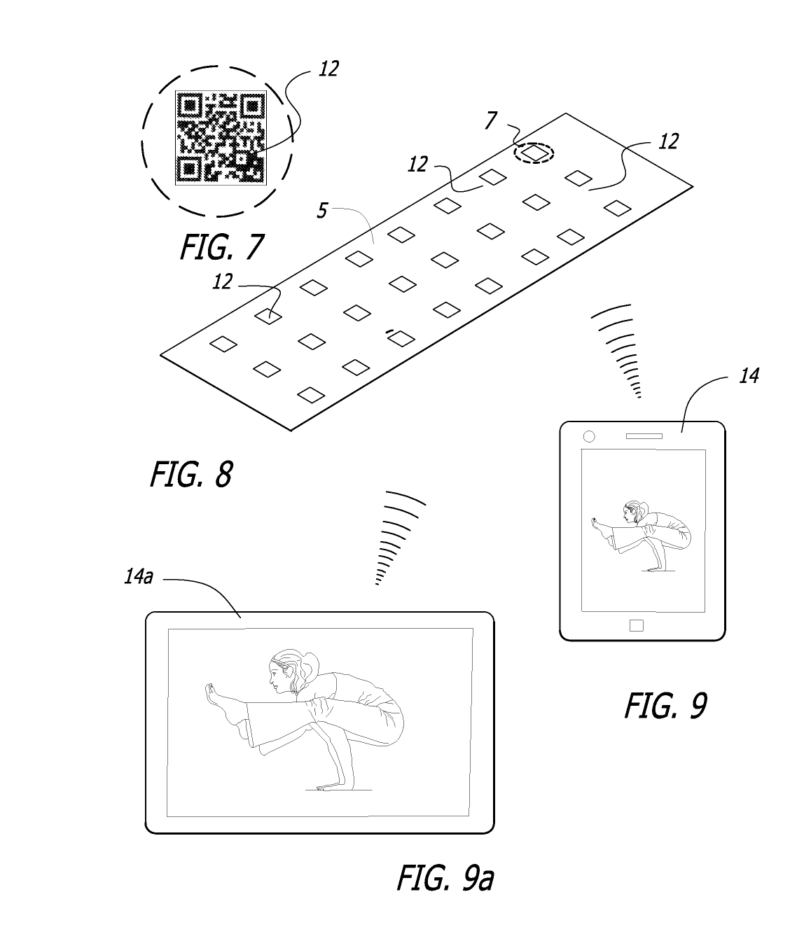

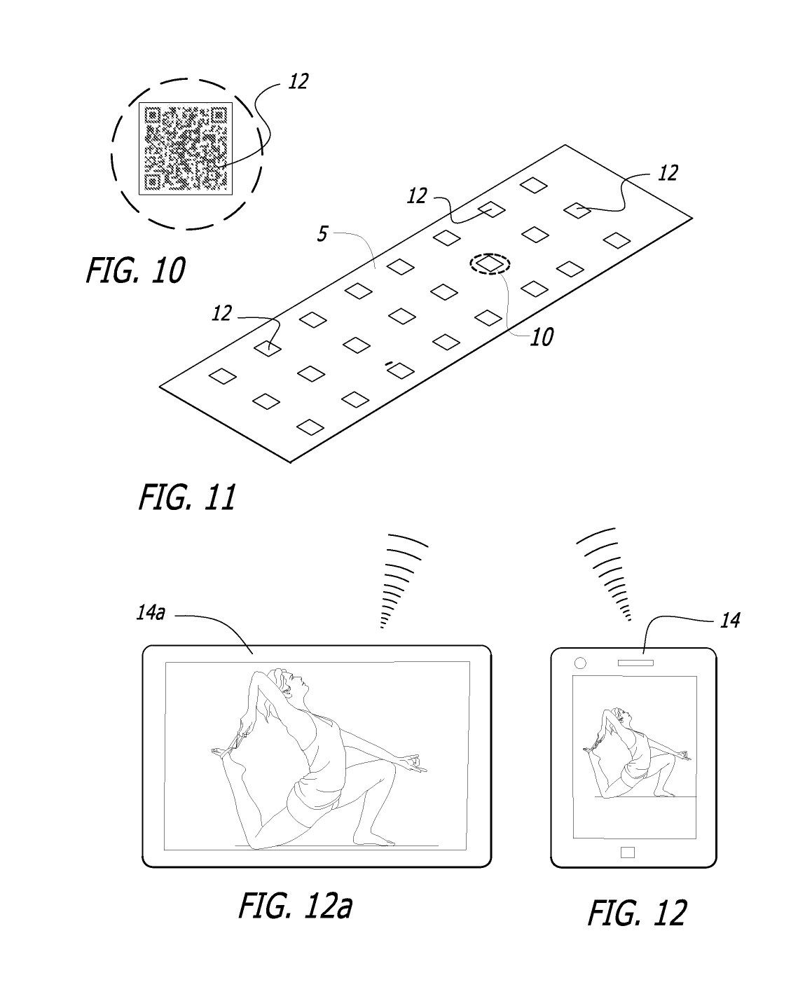

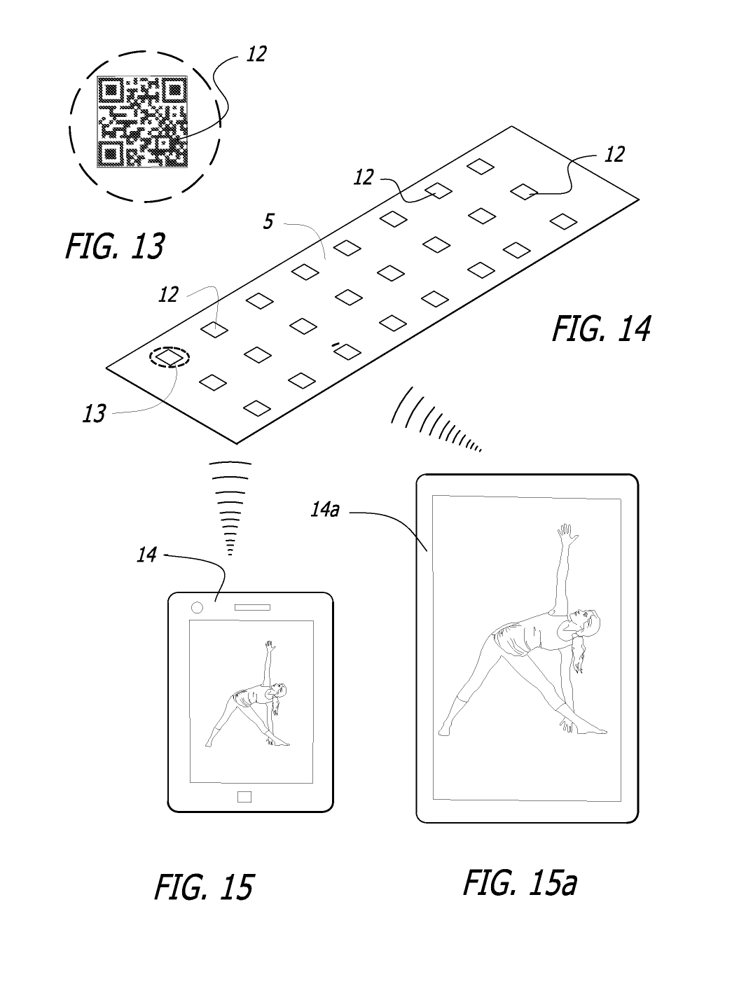

FIGS. 7-15a illustrate the process of utilizing the printed QR codes 12 in order to perform a series of exercises. The QR code 7 of FIG. 7 directs the user to a yoga pose. The QR code 10 of FIG. 10 directs the user to a pilates exercise. And the QR code 13 of FIG. 13 directs the user to a cardio exercise.

Although several embodiments have been described in detail for purposes of illustration, various modifications may be made to each without departing from the scope and spirit of the invention.

What is claimed is:

1. An exercise apparatus, comprising:
a rollable, flexible exercise mat; and
a plurality of quick response (QR) codes visible on a surface of the exercise mat;
wherein the QR codes, when scanned by a QR code reader, open one or more websites to illustrate an exercise to be performed utilizing the exercise mat.

2. The exercise mat of claim 1, wherein the flexible exercise mat comprises a yoga mat, and wherein the QR codes open one or more websites directed to yoga, pilates, stretch and/or cardio exercises.

3. The exercise apparatus of claim 2, including a visual illustration associated with one or more of the QR codes, illustrating the exercise to be performed utilizing the exercise mat.

4. The exercise apparatus of claim 2, wherein the QR codes associated with a similar type of exercise are grouped together.

5. The exercise apparatus of claim 1, wherein the exercise mat includes a non-skid or quick-drying surface.

6. The exercise apparatus of claim 1, wherein the exercise mat comprises an antibacterial or antimicrobial material.

7. The exercise apparatus of any of claims 1-6, including a tablet computer or a hand-held mobile device comprising an integrated camera, software for decoding the QR codes on the exercise mat, an on-board web browser, and means for connecting to the Internet.

8. A process for utilizing the exercise apparatus of any of claims 1-6, including the steps of:
providing a tablet computer or a hand-held mobile device comprising an integrated camera, software for decoding the QR codes on the exercise mat, an on-board web browser, and means for connecting to the Internet;
utilizing the integrated camera to scan a selected QR code on the flexible exercise mat;
decrypting the information provided by the selected QR code by means of the software provided within the tablet computer or the hand-held mobile device; and
displaying content from a website on the Internet and accessed through the web browser relating to the scanned QR code.

9. The process of claim 8, wherein the website comprises text, pictures and/or embedded videos describing or demonstrating the exercise associated with the QR code.

10. The process of claim 9, wherein the website describes or demonstrates a single exercise or a progression through a series of exercises.
